(19) United States
(12) Patent Application Publication
(10) Pub. No.: US 2021/0382383 A1
(43) Pub. Date: Dec. 9, 2021

(54) ILLUMINATOR AND PROJECTOR

(71) Applicant: SEIKO EPSON CORPORATION, Tokyo (JP)

(72) Inventor: Ryuta KOIZUMI, Shiojiri-shi (JP)

(73) Assignee: SEIKO EPSON CORPORATION, Tokyo (JP)

(21) Appl. No.: 17/337,654

(22) Filed: Jun. 3, 2021

(30) Foreign Application Priority Data
Jun. 4, 2020 (JP) 2020-097456

(51) Int. Cl. G03B 21/20; G02B 27/14

(52) U.S. Cl. CPC G03B 21/2073; G02B 27/141; G03B 21/204; G03B 21/2066; G03B 21/208; G03B 21/2013

(57) ABSTRACT

An illuminator includes first and second light emitters outputting first and second lights, a wavelength converter having first and second surfaces, a first optical element reflecting one of the set of the first light and the second light and a third light and transmits the other, a first focusing system between the light emitters and first optical element and having positive power, and a second focusing system between the first optical element and wavelength converter. The second focusing system has a focal point between the second focusing system principal point and wavelength converter second surface, and

D1/C1<B1/A1≤1 (1)

where C1 represents the lengthwise size of each light exiting surface, D1 the widthwise size of each light exiting surface, A1 the lengthwise size of a luminous flux cross section including the first and second lights, and B1 the widthwise size of the cross section therebetween.

The present application is based on, and claims priority from JP Application Serial Number 2020-097456, filed Jun. 4, 2020, the disclosure of which is hereby incorporated by reference herein in its entirety.

### BACKGROUND

### 1. Technical Field

The present disclosure relates to an illuminator and a projector.

### 2. Related Art

As a light source apparatus used in a projector, there has been a proposed light source apparatus using fluorescence emitted from a phosphor when the phosphor is irradiated with excitation light outputted from a light emitter. JP-A-2019-8193 discloses a light source apparatus including a first light sources that emits the excitation light, a second light source that emits fluorescence by the irradiation with the excitation light, and a dichroic mirror that reflects the excitation light and transmits the fluorescence. JP-A-2019-8193 further describes a light source apparatus having a configuration in which a focusing lens is provided between the laser light source that emits the excitation light and the dichroic mirror.

JP-A-2017-97310 discloses a light source apparatus including a light source optical system including a plurality of laser light sources, a microlens array on which light from the light source optical system is incident, a phosphor that converts part of blue light outputted from the laser light sources into yellow fluorescence, a dichroic mirror that reflects the blue light and transmits the fluorescence, and a focusing lens unit that focuses the blue light having exited out of the dichroic mirror onto the phosphor.

A light source apparatus including a plurality of light emitters, a dichroic mirror, and a focusing lens provided between the plurality of light emitters and the dichroic mirror is assumed by combining the configuration of JP-A-2019-8193 and the configuration of JP-A-2017-97310. The light source apparatus has a configuration in which a first focusing lens is provided between the plurality of light emitters and the dichroic mirror in addition to a second focusing lens provided in the vicinity of the phosphor.

In the light source apparatus having the configuration described above, the position where the excitation light is brought into focus shifts from the phosphor due to the effect of the first focusing lens, so that the image of the excitation light on the phosphor is affected by the arrangement of the plurality of light emitters. For example, when a plurality of light beams enter the first focusing lens and the second focusing lens with the plurality of light emitters arranged in a row, a plurality of excitation light images formed on the phosphor are also arranged in a row, as described in JP-A-2017-97310. As described above, when the images of the excitation light are so shaped as to be elongated in one direction, the luminance distribution of the fluorescence emitted from the phosphor also has a shape elongated in one direction. Using such a light source apparatus as an illuminator for a projector causes a problem of a difficulty in efficient uses of illumination light.

### SUMMARY

To solve the problem described above, an illuminator according to an aspect of the present disclosure includes a first light emitter that has a first light exiting surface and outputs first light that belongs to a first wavelength band via the first light exiting surface, a second light emitter that has a second light exiting surface and outputs second light that belongs to the first wavelength band via the second light exiting surface, a wavelength converter that has a first surface on which the first light and the second light are incident and a second surface different from the first surface and converts the first light and the second light into third light that belongs to a second wavelength band different from the first wavelength band, a first optical element that reflects one of a set of the first light and the second light and the third light and transmits the other of the set of the first light and the second light and the third light, a first focusing system that is provided between a set of the first light emitter and the second light emitter and the first optical element and has positive power, and a second focusing system provided between the first optical element and the wavelength converter, in which the second focusing system has a focal point located between a principal point of the second focusing system and the second surface of the wavelength converter, the first light exiting surface and the second light exiting surface have the same size, and

D1/C1<B1/A1≤1 (1)

where C1 represents a lengthwise size of the first light exiting surface and the second light exiting surface, D1 represents a widthwise size of the first light exiting surface and the second light exiting surface, A1 represents a lengthwise size of a cross section of a luminous flux that is a combination of the first light and the second light, the cross section being perpendicular to a chief ray of the luminous flux, between the set of the first light emitter and the second light emitter and the first optical element, and B1 represents a widthwise size of the cross section therebetween.

An illuminator according to another aspect of the present disclosure includes a first light emitter that outputs first light that belongs to a first wavelength band, a second light emitter that outputs second light that belongs to the first wavelength band, a wavelength converter that has a first surface on which the first light and the second light are incident and a second surface different from the first surface and converts the first light and the second light into third light that belongs to a second wavelength band different from the first wavelength band, a first optical element that reflects one of a set of the first light and the second light and the third light and transmits another of the set of the first light and the second light and the third light, a first focusing system that is provided between a set of the first light emitter and the second light emitter and the first optical element and has positive power, and a second focusing system provided between the first optical element and the wavelength converter, in which the second focusing system has a focal point located between a principal point of the second focusing system and the second surface of the wavelength converter, a first cross section perpendicular to a chief ray of the first light and a second cross section perpendicular to a chief ray of the second light have the same size between the set of the first light emitter and the second light emitter and the first optical element, and

D2/C2<B2/A2≤1 (2)

where between the set of the first light emitter and the second light emitter and the first optical element, C2 represents a lengthwise size of the first cross section and the second cross section, D2 represents a widthwise size of the first cross section and the second cross section, A2 represents a lengthwise size of a third cross section of a luminous flux that is a combination of the first light and the second light, the cross section being perpendicular to a chief ray of the luminous flux, and B2 represents a widthwise size of the third cross section therebetween.

A projector according to another aspect of the present disclosure includes the illuminator according to the aspect of the present disclosure, a light modulator that modulates light from the illuminator in accordance with image information, and a projection optical apparatus that projects the light modulated by the light modulator.

### BRIEF DESCRIPTION OF THE DRAWINGS

FIG. 1 is a schematic configuration diagram of a projector according to a first embodiment.

FIG. 2 is a plan view of an illuminator according to the first embodiment.

FIG. 3 is a side view of a light source apparatus.

FIG. 4 is a perspective view of a first light emitter.

FIG. 5 shows the cross-sectional shape of first light outputted from the first light emitter.

FIG. 6 shows the cross-sectional shape of a luminous flux.

FIG. 7 shows the intensity distribution of the luminous flux on a wavelength conversion layer.

FIG. 8 is a plan view of an illuminator according to a second embodiment.

FIG. 9 shows the cross-sectional shape of the luminous flux.

FIG. 10 shows the intensity distribution of the luminous flux on the wavelength conversion layer.

FIG. 11 is a plan view of an illuminator according to a third embodiment.

FIG. 12 shows the cross-sectional shape of the luminous flux.

FIG. 13 shows the intensity distribution of the luminous flux on the wavelength conversion layer.

FIG. 14 is a plan view of an illuminator according to a fourth embodiment.

FIG. 15 shows the cross-sectional shape of the luminous flux.

FIG. 16 shows the intensity distribution of the luminous flux on the wavelength conversion layer.

### DESCRIPTION OF EXEMPLARY EMBODIMENTS

### First embodiment

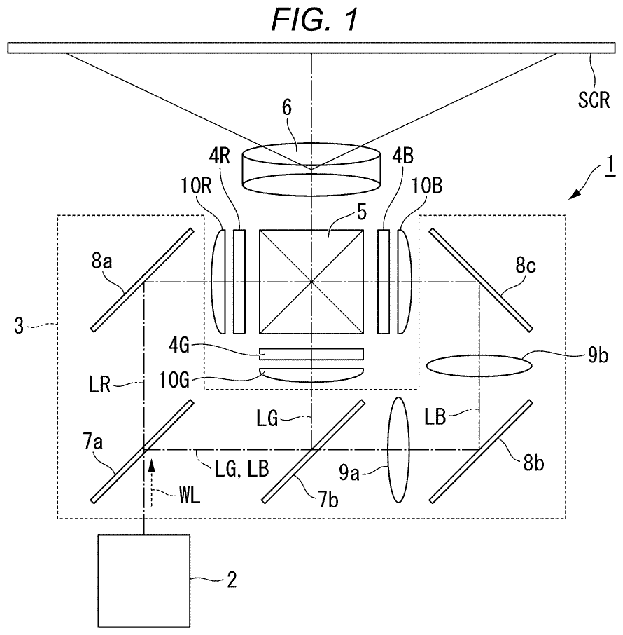

A first embodiment of the present disclosure will be described below with reference to FIGS. 1 to 7.

In the following drawings, components are drawn at different dimensional scales in some cases for clarification of each of the components.

An example of a projector according to the present embodiment will be described.

FIG. 1 is a schematic configuration diagram of the projector according to the present embodiment.

A projector 1 according to the present embodiment is a projection-type image display apparatus that displays color video images on a screen SCR, as shown in FIG. 1. The projector 1 includes an illuminator 2, a color separation system 3, light modulators 4R, 4G, and 4B, a light combining system 5, and a projection optical apparatus 6. The configuration of the illuminator 2 will be described later.

The color separation system 3 includes a first dichroic mirror 7a, a second dichroic mirror 7b, reflection mirrors 8a, 8b, and 8c, and relay lenses 9a and 9b. The color separation system 3 separates illumination light WL outputted from the illuminator 2 into red light LR, green light LG, and blue light LB, guides the red light LR to the light modulator 4R, guides the green light LG to the light modulator 4G, and guides the blue light LB to the light modulator 4B.

A field lens 10R is disposed between the color separation system 3 and the light modulator 4R, substantially parallelizes incident light, and causes the resultant light to exit toward the light modulator 4R. A field lens 10G is disposed between the color separation system 3 and the light modulator 4G, substantially parallelizes incident light, and causes the resultant light to exit toward the light modulator 4G. A field lens 10B is disposed between the color separation system 3 and the light modulator 4B, substantially parallelizes incident light, and causes the resultant light to exit toward the light modulator 4B.

The first dichroic mirror 7a transmits a red light component and reflects a green light component and a blue light component. The second dichroic mirror 7b reflects the green light component and transmits the blue light component. The reflection mirror 8a reflects the red light component. The reflection mirrors 8b and 8c reflect the blue light component.

The red light LR having passed through the first dichroic mirror 7a is reflected off the reflection mirror 8a, passes through the field lens 10R, and is incident on an image formation area of the light modulator 4R for red light. The green light LG reflected off the first dichroic mirror 7a is further reflected off the second dichroic mirror 7b, passes through the field lens 10G, and is incident on an image formation area of the light modulator 4G for green light. The blue light LB having passed through the second dichroic mirror 7b travels via the relay lens 9a, the light-incident-side reflection mirror 8b, the relay lens 9b, the light-exiting-side reflection mirror 8c, and the field lens 10B and is incident on an image formation area of the light modulator 4B for blue light.

The light modulators 4R, 4G, and 4B each modulate the color light incident thereon in accordance with image information to form image light. The light modulators 4R, 4G, and 4B are each formed of a liquid crystal light valve. Although not shown, a light-incident-side polarizer is disposed on the light incident side of each of the light modulators 4R, 4G, and 4B. A light-exiting-side polarizer is disposed on the light exiting side of each of the light modulators 4R, 4G, and 4B.

The light combining system 5 combines the image light outputted from the light modulator 4R, the image light outputted from the light modulator 4G, and the image light outputted from the light modulator 4B with one another to form full-color image light. The light combining system 5 is formed of a cross dichroic prism formed of four right angled prisms bonded to each other and having a substantially square shape in a plan view. Dielectric multilayer films are formed along the substantially X-letter-shaped interfaces between the right angled prisms bonded to each other.

The image light having exited out of the light combining system 5 is enlarged and projected by the projection optical apparatus 6 to form an image on the screen SCR. That is, the projection optical apparatus 6 projects the light modulated by the light modulators 4R, 4G, and 4B. The projection optical apparatus 6 is formed of a plurality of projection lenses.

An example of the illuminator 2 according to the present embodiment will be described.

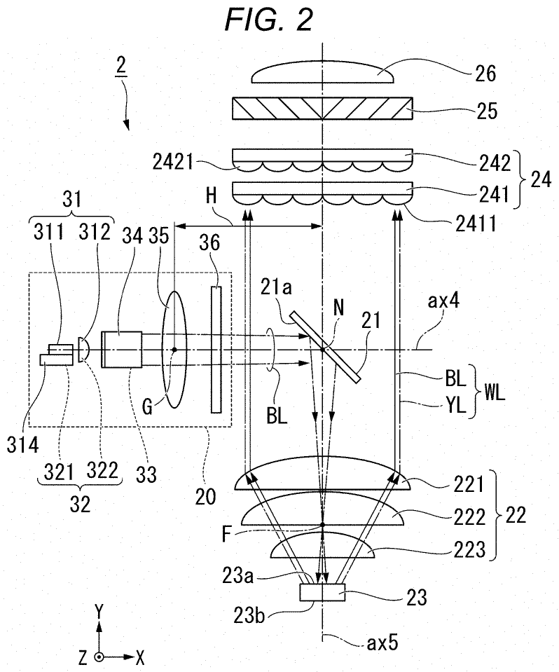

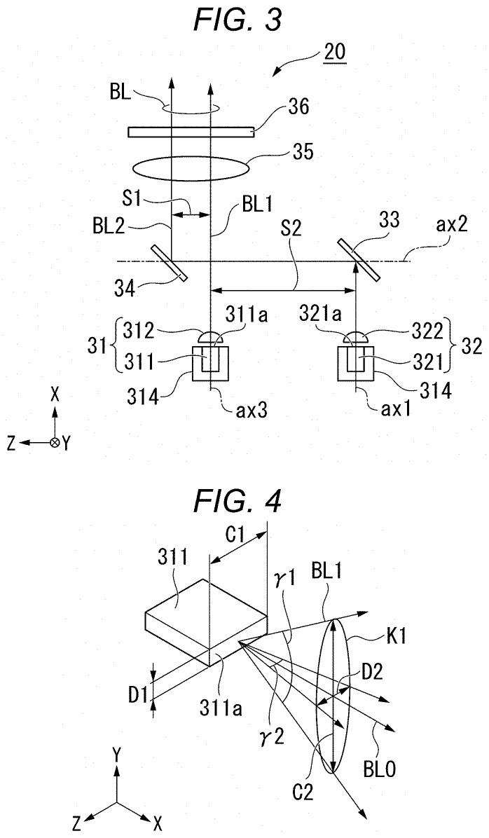

In FIGS. 2 and 3 and in the following description, an XYZ orthogonal coordinate system is used, and the axes thereof are defined as follows: An axis X is an axis parallel to the chief ray of a luminous flux BL outputted from a light source apparatus 20; an axis Y is an axis parallel to the chief ray of fluorescence YL emitted from a wavelength converter 23; and an axis Z is an axis perpendicular to the axes X and Y.

FIG. 2 is a plan view of the illuminator 2 viewed in the axis-Z direction. FIG. 3 is a side view of the light source apparatus 20 provided in the illuminator 2 and viewed in the axis-Y direction.

The illuminator 2 according to the present embodiment includes the light source apparatus 20, a dichroic mirror 21, a second focusing system 22, the wavelength converter 23, an optical integration system 24, a polarization converter 25, and a superimposing lens 26, as shown in FIG. 2.

The light source apparatus 20 includes a first light source unit 31, a second light source unit 32, a first light combining mirror 33, a second light combining mirror 34, a first focusing system 35, and diffuser 36, as shown in FIG. 3. The first light source unit 31 includes a first light emitter 311 and a first collimator lens 312. The second light source unit 32 includes a second light emitter 321 and a second collimator lens 322.

The first light emitter 311 has a first light exiting surface 311a and outputs first light BL1, which belongs to a first wavelength band, via the first light exiting surface 311a in the direction +X. The second light emitter 321 has a second light exiting surface 321a and outputs second light BL2, which belongs to the first wavelength band, via the second light exiting surface 321a in the direction +X. The first light emitter 311 and the second light emitter 321 are arranged along the axis-Z direction with a distance therebetween. The first light emitter 311 and the second light emitter 321 are mounted on bases 314.

The first light emitter 311 and the second light emitter 321 are each formed of a blue semiconductor laser that outputs blue light. The blue semiconductor laser outputs blue light having a peak wavelength that falls within, for example, a range from 380 to 495 nm as the first wavelength band. The light source apparatus 20 therefore outputs the first light BL1 and the second light BL2 formed of two blue light beams arranged in the axis-Z direction. The first light emitter 311 and the second light emitter 321 may be formed of blue semiconductor lasers that output blue light having the same peak wavelength or may be formed of blue semiconductor lasers that output blue light having different peak wavelengths.

The first collimator lens 312 is provided in correspondence with the first light emitter 311. The first collimator lens 312 parallelizes the first light BL1 outputted from the first light emitter 311. The second collimator lens 322 is provided in correspondence with the second light emitter 321. The second collimator lens 322 parallelizes the second light BL2 outputted from the second light emitter 321.

The first light combining mirror 33 is so disposed that the reflecting surface thereof inclines by an angle of 45° with respect to an optical axis ax1 along the chief ray of the second light BL2 outputted from the second light emitter 321. The blue light BL2 outputted from the second light emitter 321 in the direction +X is therefore then reflected off the first light combining mirror 33 and travels in the direction +Z. The second light combining mirror 34 is so disposed that the reflection surface thereof inclines by the angle of 45° with respect to an optical axis ax2 along the chief ray of the blue light BL2 reflected off the first light combining mirror 33. The blue light BL2 therefore travels from the first light combining mirror 33 in the direction +Z, is then reflected off the second light combining mirror 34, and travels in the direction +X.

On the other hand, the first light BL1 outputted from the first light emitter 311 is not incident on the first light combining mirror 33 or the second light combining mirror 34 but travels along an optical axis ax3 from the first light emitter 311 in the direction +X. Since the optical path of the second light BL2 is deflected by the first light combining mirror 33 and the second light combining mirror 34, a distance S1 between the first light BL1 and the second light BL2 in the positions after the second light BL2 is reflected off the second light combining mirror 34 is narrower than a distance S2 between the first light BL1 and the second light BL2 in the positions immediately after the first light BL1 and the second light BL2 are outputted from the first light emitter 311 and the second light emitter 321. The first light BL1 and the second light BL2 are thus combined with each other by the first light combining mirror 33 and the second light combining mirror 34 into the luminous flux BL. That is, the luminous flux BL means an entire luminous flux including the first light BL1 and the second light BL2. The chief ray of the luminous flux BL is defined as the center axis of the luminous flux including the first light BL1 and the second light BL2. The distance S1 and the distance S2 are each defined as a distance in the direction along the optical axis ax2.

That is, the first light combining mirror 33 and the second light combining mirror 34 are provided between the set of the first light emitter 311 and the second light emitter 321 and the dichroic mirror 21, and at least one of the first light BL1 outputted from the first light emitter 311 and the second light BL2 outputted from the second light emitter 321 is incident on the first light combining mirror 33 and the second light combining mirror 34, which combine the first light BL1 and the second light BL2 with each other.

The first light combining mirror 33 and the second light combining mirror 34 in the present embodiment each correspond to the second optical element in the appended claims.

The first focusing system 35 is provided between the set of the first light emitter 311 and the second light emitter 321 and the dichroic mirror 21. That is, the first focusing system 35 is provided between the set of the first light combining mirror 33 and the second light combining mirror 34 and the diffuser 36. In the present embodiment, the first focusing system 35 is formed of a single convex lens. The number of lenses that form the first focusing system 35 is not limited to a specific number, and the first focusing system 35 may be formed of a plurality of lenses. The first focusing system 35 focuses the luminous flux BL incident thereon. The first focusing system 35 has positive power and has a focal point F located between the second focusing system 22 and the wavelength converter 23. The focal length of the first focusing system 35 is longer than a distance H between a principal point G of the first focusing system 35 and a light incident point N, where the luminous flux BL is incident on the dichroic mirror 21.

The light incident point N, where the luminous flux BL is incident on the dichroic mirror 21, is defined as the point where the chief ray of the luminous flux BL intersects a light incident surface 21a of the dichroic mirror 21. The distance H between the principal point G of the first focusing system 35 and the light incident point N, where the luminous flux BL is incident on the dichroic mirror 21, is defined as the distance along an optical axis ax4, along which the chief ray of the luminous flux BL travels. The first focusing system 35 may be formed of a plurality of lenses. When the first focusing system 35 is formed of a plurality of lenses, the principal point G of the first focusing system 35 is defined as the principal point of the entire focusing system formed of the plurality of lenses.

The diffuser 36 is provided between the first focusing system 35 and the dichroic mirror 21. The diffuser 36 diffuses the luminous flux BL having exited out of the first focusing system 35 and causes the diffused luminous flux BL to exit toward the dichroic mirror 21. The diffuser 36 thus homogenizes the illuminance distribution of the luminous flux BL on the wavelength converter 23. The diffuser 36 is, for example, a ground glass plate made of optical glass. The diffuser 36 is a light transmissive diffuser.

The dichroic mirror 21 is so disposed as to incline by an angle of 45° with respect to each of the optical axis ax4 along the chief ray of the luminous flux BL outputted from the light source apparatus 20 and an optical axis ax5 along the chief ray of the fluorescent YL emitted from the wavelength converter 23, as shown in FIG. 2. The dichroic mirror 21 is so characterized as to reflect light that belongs to a blue wavelength band and transmit light that belongs to a yellow wavelength band. The dichroic mirror 21 therefore reflects the luminous flux BL outputted from the light source apparatus and transmits the fluorescence YL emitted from the wavelength converter 23. The dichroic mirror 21 in the present embodiment corresponds to the first optical element in the appended claims.

The second focusing system 22 is provided between the dichroic mirror 21 and the wavelength converter 23. The second focusing system 22 is formed of three convex lenses formed of a first lens 221, a second lens 222, and a third lens 223. The number of lenses that form the second focusing system 22 is not limited to a specific number. The second focusing system 22 focuses the luminous flux BL reflected off the dichroic mirror 30 and causes the focused luminous flux BL to enter the wavelength converter 23. The second focusing system 22 has a focal point located between the principal point of the second focusing system 22 and a second surface 23b of the wavelength converter 23. In the present embodiment, since the second focusing system 22 is formed of the plurality of lenses, the principal point of the second focusing system 22 is defined as the principal point of the entire focusing system formed of the plurality of lenses.

The wavelength converter 23 converts the luminous flux BL having exited out of the second focusing system 22 into the fluorescence YL, which belongs to a second wavelength band different from the first wavelength band. The wavelength converter 23 contains a ceramic phosphor that converts the blue luminous flux BL into the yellow fluorescence YL. The second wavelength band ranges, for example, from 490 to 750 nm, and the fluorescence YL is yellow light containing the green light component and the red light component. The phosphor may contain a monocrystalline phosphor. The wavelength converter 23 has a substantially square planar shape when viewed in the direction in which the luminous flux BL is incident (axis-Y direction) . The wavelength converter 23 has a first surface 23a, on which the luminous flux BL, which the combination of the first light BL1 and the second light BL2, is incident, and the second surface 23b different from the first surface 23a. The first surface 23a and the second surface 23b face each other via the entity of the wavelength converter 23.

The fluorescence YL in the present embodiment corresponds to the third light in the appended claims.

The wavelength converter 23 contains, for example, an yttrium-aluminum-garnet-based (YAG-based) phosphor. Consider YAG:Ce, which contains cerium (Ce) as an activator, by way of example, and the YAG:Ce phosphor can be made, for example, of a material produced by mixing raw powder materials containing Y₂O₃, Al₂O₃, CeO₃, and other constituent elements with one another and causes the mixture to undergo a solid-phase reaction, Y—Al—O amorphous particles produced by using a coprecipitation method, a sol-gel method, or any other wet method, or YAG particles produced by using a spray-drying method, a flame-based thermal decomposition method, a thermal plasma method, or any other gas-phase method, as a phosphor. The phosphor contains a scattering element that scatters the luminous flux BL and the fluorescence YL. The scattering element is formed, for example, of a plurality of pores.

In the present embodiment, since the first focusing system 35 having positive power is provided between the set of the first light emitter 311 and the second light emitter 321 and the dichroic mirror 21, the luminous flux BL in the form of a convergent luminous flux is incident on the dichroic mirror 21. The size of the dichroic mirror 21 can therefore be reduced as compared with a case where no first focusing system 35 is provided. Since the dichroic mirror 21 is so characterized as to transmit a yellow light component, the fluorescence YL emitted from the wavelength converter 23 passes through the second focusing system 22 and then passes through the dichroic mirror 21.

On the other hand, out of the luminous flux BL having entered the wavelength converter 23, part of the luminous flux BL is converted in terms of wavelength into the fluorescence YL, whereas the other part of the luminous flux BL is backscattered by the scattering element contained in the phosphor before converted in terms of wavelength into the fluorescence YL and caused to exit out of the wavelength converter 23 without undergoing the wavelength conversion. In this process, the luminous flux BL exits in the form of a diffused luminous flux having an angular distribution that is substantially the same as the angular distribution of the fluorescence YL. Therefore, when the size of the dichroic mirror 21 is reduced, a central portion of the luminous flux BL is incident on the dichroic mirror 21, but a peripheral portion of the luminous flux BL is not incident on the dichroic mirror 21 but passes through the space outside the dichroic mirror 21, as described above. The luminous flux BL incident on the dichroic mirror 21 is reflected off the dichroic mirror 21 and lost, but the luminous flux BL that is not incident on the dichroic mirror 21 is used along with the fluorescence YL as the illumination light WL. The luminous flux BL that exits out of the wavelength converter 23 may instead be generated by causing the luminous flux BL to be diffusively reflected off the surface of the wavelength converter 23 without entering the wavelength converter 23.

The luminous flux BL and the fluorescence YL thus enter the optical integration system 24. The blue luminous flux BL and the yellow fluorescence YL are combined with each other to produce the white illumination light WL.

The optical integration system 24 includes a first multi-lens array 241 and a second multi-lens array 242. The first multi-lens array 241 includes a plurality of first lenses 2411, which divide the illumination light WL into a plurality of sub-luminous fluxes.

The lens surface of the first multi-lens array 241, that is, the surfaces of the first lenses 2411 are conjugate with the image formation area of each of the light modulators 4R, 4G, and 4B. Therefore, when viewed in the direction of the optical axis ax5, the first lenses 2411 each have a rectangular shape substantially similar to the shape of the image formation area of each of the light modulators 4R, 4G, and 4B. The sub-luminous fluxes having exited out of the first multi-lens array 241 are thus each efficiently incident on the image formation area of each of the light modulators 4R, 4G, and 4B.

The second multi-lens array 242 includes a plurality of second lenses 2421 corresponding to the plurality of first lenses 2411 of the first multi-lens array 241. The second multi-lens array 242 along with the superimposing lens 26 brings images of the first lenses 2411 of the first multi-lens array 241 into focus in the vicinity of the image formation area of each of the light modulators 4R, 4G, and 4B.

The illumination light WL having passed through the optical integration system 24 enters the polarization converter 25. The polarization converter 25 has a configuration in which polarization separation films and retardation films that are not shown are arranged in an array. The polarization converter 25 aligns the polarization directions of the illumination light WL with a predetermined direction. Specifically, the polarization converter 25 aligns the polarization directions of the illumination light WL with the direction of the transmission axis of the light-incident-side polarizers for the light modulators 4R, 4G, and 4B.

The polarization directions of the red light LR, the green light LG, and the blue light LB separated from the illumination light WL having passed through the polarization converter 25 coincide with the transmission axis direction of the light-incident-side polarizers for the light modulators 4R, 4G, and 4B. The red light LR, the green light LG, and the blue light LB are therefore incident on the image formation areas of the light modulators 4R, 4G, and 4B, respectively, without being blocked by the light-incident-side polarizers.

The illumination light WL having passed through the polarization converter 25 enters the superimposing lens 26. The superimposing lens 26, in cooperation with the optical integration system 24, homogenizes the illuminance distribution in the image formation area of each of the light modulators 4R, 4G, and 4B, which are illumination receiving areas.

FIG. 4 is a perspective view showing how the first light BL1 is outputted from the first light emitter 311. The first light emitter 311 and the second light emitter 321 have the same configuration, and the first light emitter 311 will therefore be representatively described below. In FIG. 4, the base 314 shown in FIGS. 2 and 3 is omitted.

The first light emitter 311 formed of a semiconductor laser has the first light exiting surface 311a, via which the first light BL1 exits, as shown in FIG. 4. The first light exiting surface 311a has an oblong planar shape when viewed in the direction of a chief ray BL0 of the first light BL1. Let C1 be the lengthwise dimension of the oblong planar shape of the first light exiting surface 311a and D1 be the widthwise dimension thereof, and the ratio D1/C1 of the widthwise dimension D1 to the lengthwise dimension C1 is, for example, 1/40. Specifically, the lengthwise dimension C1 of the first light exiting surface 311a is, for example, 40 μm. The widthwise dimension D1 of the first light exiting surface 311a is, for example, 1 μm. The dimensions of the first light exiting surface 311a are not limited to those in the example described above.

The size of the first light exiting surface 311a of the first light emitter 311 and the size of the second light exiting surface 321a of the second light emitter 321 are equal to each other. The second light exiting surface 321a therefore has an oblong planar shape when viewed in the direction of the chief ray of the second light BL2, as the first light exiting surface 311a does. As for the second light exiting surface 321a, the ratio D1/C1 of the widthwise dimension D1 of the oblong shape to the lengthwise dimension C1 thereof is also, for example, 1/40.

The first light emitter 311 outputs the first light BL1 having an elliptical cross-sectional shape perpendicular to the chief ray BL0. Let K1 be a first cross section of the first light BL1 outputted from the first light emitter 311 perpendicular to the chief ray BL0, and the first cross section K1 has an elliptical shape. The lengthwise direction of the oblong shape of the first light exiting surface 311a coincides with the widthwise direction of the elliptical shape of the first cross section K1. The widthwise direction of the oblong shape of the first light exiting surface 311a coincides with the lengthwise direction of the elliptical shape of the first cross section K1. The reason for this is that the first light BL1 outputted from the first light emitter 311 diverges as follows: An angle of divergence γ1 in a plane perpendicular to the lengthwise direction of the first light exiting surface 311a is greater than an angle of divergence γ2 in a plane perpendicular to the widthwise direction of the first light exiting surface 311a. The maximum value of the angle of divergence γ1 (maximum radiation angle) of the first light BL1 is, for example, 70°, and the maximum value of the angle of divergence γ2 (maximum radiation angle) of the first light BL1 is, for example, 20°.

Therefore, let C2 be the lengthwise dimension of the first cross section K1 and D2 be the widthwise dimension of the first cross section K1, the ratio D2/C2 of the widthwise dimension D2 of the first cross section K1 to the lengthwise dimension C2 of the first cross section K1 is sufficiently smaller than 1.

Although not shown, assuming that the cross section of the second light BL2 outputted from the second light emitter 321 perpendicular to the chief ray of the second light BL2 is a second cross section, as in the case of the first light emitter 311, the first cross section K1 and the second cross section have the same size in the portion between the set of the first light emitter 311 and the second light emitter 321 and the dichroic mirror 21. Therefore, let C2 be the lengthwise dimension of the second cross section and D2 be the widthwise dimension of the second cross section, and the ratio D2/C2 of the widthwise dimension D2 of the second cross section to the lengthwise dimension C2 of the second cross section is sufficiently smaller than 1.

Since the first light BL1 and the second light BL2 are each diffused light, the lengthwise dimension C2 and the widthwise dimension D2 of the cross section of each of the first light BL1 and the second light BL2 vary depending on the location, but the ratio D2/C2 is fixed irrespective of the location.

### Principle of Present Embodiment

Assuming that the first focusing system 35 is not provided in the illuminator 2 according to the present embodiment, the luminous flux BL formed of the first light BL1 outputted from the first light emitter 311 and the second light BL2 outputted from the second light emitter 321 is focused on the wavelength converter 23 by the second focusing system 22 provided between the dichroic mirror 21 and the wavelength converter 23. That is, the focal point of the second focusing system 22 is so set as to be located between the principal point of the second focusing system 22 and the second surface 23b of the wavelength converter 23.

However, in the present embodiment, to reduce the size of the dichroic mirror 21, the first focusing system 35 is provided between the set of the first light emitter 311 and the second light emitter 321 and the dichroic mirror 21. Further, since the second focusing system 22 has a focal point between the principal point of the second focusing system 22 and the second surface 23b of the wavelength converter 23, the position where the luminous flux width of the luminous flux BL is minimized shifts toward the opposite side of the wavelength converter 23 from the side where the second focusing system 22 is provided. The image of the luminous flux on the first surface 23a of the wavelength converter 23 is therefore defocused. Since the luminous flux BL shifted from the point where the luminous flux BL is focused spreads in the shape of the luminance distribution of the light immediately after outputted from each of the light emitters 311 and 321, the image of the luminous flux on the wavelength converter 23 also has a shape along the luminance distribution.

The present inventor has conducted a simulation of the luminance distribution of the light at a variety of locations in the illuminator.

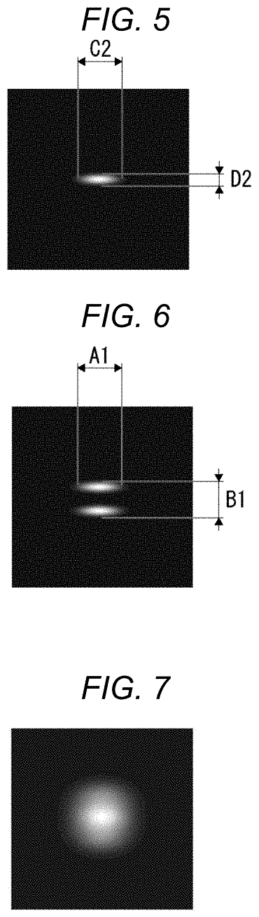

FIG. 5 shows the luminance distribution of the first light BL1 outputted from the first light emitter 311. It is assumed in the following results of the simulation that the shape of the luminance distribution of each of the first light BL1 and the second light BL2 coincides with the cross-sectional shape perpendicular to the chief ray of the light. The luminance distribution of the second light BL2 outputted from the second light emitter 321 is the same as the luminance distribution of the first light BL1.

Let C2 be the lengthwise dimension of the first cross section K1 of the first light BL1 and D2 be the widthwise dimension of the first cross section K1, and the ratio D2/C2 of the widthwise dimension D2 of the first cross section K1 to the lengthwise dimension C2 of the first cross section K1 is sufficiently smaller than 1, as shown in FIG. 5.

As described above, when light having a cross-sectional shape elongated in one direction is caused to enter a wavelength converter, the cross-sectional shape of the fluorescence emitted from the wavelength converter is also elongated in one direction. A large difference between the lengthwise dimension and the widthwise dimension of the cross-sectional shape of fluorescence causes variation in the angle of the chief ray of the fluorescence emitted from an end portion of the wavelength converter. As a result, the shape of the illumination receiving area of each optical element on the downstream of the wavelength converter is also elongated, resulting in a problem of a decrease in fluorescence utilization efficiency when part of the fluorescence cannot be incident on an optical element having a circular or square shape when viewed in the light incident direction. On the other hand, designing an optical element in such a way that the entire fluorescence having the elongated cross-sectional shape can be incident on the optical element causes a problem of an increase in the size of the optical element.

FIG. 6 shows the luminance distribution of the luminous flux BL after the first light BL1 and the second light BL2 are combined with each other.

To solve the problems described above, in the illuminator 2 according to the present embodiment, the first light combining mirror 33 and the second light combining mirror 34 are used to arrange the first light BL1 and the second light BL2 in the widthwise direction of the cross sections thereof, and the distance S1 along the optical axis ax2 between the first light BL1 and the second light BL2 in the positions after the second light BL2 is reflected off the second light combining mirror 34 is narrower than the distance S2 along the optical axis ax2 between the first light BL1 and the second light BL2 in the positions immediately after the first light BL1 and the second light BL2 are outputted from the first light emitter 311 and the second light emitter 321. The luminous flux BL therefore has the cross-sectional shape shown in FIG. 6. That is, let A1 be the lengthwise dimension of the cross section of the luminous flux BL and B1 be the widthwise dimension of the cross section of the luminous flux BL in FIG. 6, and the ratio B1/A1 of the dimension B1 to the dimension A1 can be a value close to 1.

Therefore, in the relationship between the lengthwise dimension C1 of each of the light exiting surfaces 311a and 321a of the first light emitter 311 and the second light emitter 321 and the widthwise dimension D1 of each of the light exiting surfaces 311a and 321a, the ratio B1/A1 satisfies Expression (1) below.

D1/C1<B1/A1≤1 (1)

Further, let A2 be the lengthwise dimension of a third cross section of the luminous flux BL and B2 be the widthwise dimension of the third cross section of the luminous flux BL, the third cross section being the cross section of the luminous flux BL, which is the combination of the first light BL1 and the second light BL2, perpendicular to the chief ray of the luminous flux BL between the set of the first light emitter 311 and the second light emitter 321 and the dichroic mirror 21. In the relationship between the lengthwise dimension C2 of the first cross section of the first light BL1 and the second cross section of the second light BL2 and the widthwise dimension D2 of the first cross section of the first light BL1 and the second cross section of the second light BL2, the ratio B2/A2 satisfies Expression (2) below.

D2/C2<B2/A2≤1 (2)

In Expressions (1) and (2) described above, A1 and A2 are equal to each other, and B1 and B2 are equal to each other. B1/A1 and B2/A2 are therefore equal to each other.

FIG. 7 shows the luminance distribution of the luminous flux BL incident on the wavelength converter 23.

In the illuminator 2 according to the present embodiment, the wavelength converter 23 is irradiated with the luminous flux BL having a cross section so shaped that the ratio of the widthwise dimension of the cross section to the lengthwise dimension thereof is close to 1, that is, the luminous flux BL having a cross-sectional shape close to a circular or square shape, as shown by Expressions (1) and (2) described above. In the present embodiment, since the luminous flux BL is diffused by the diffuser 36 and then enters the wavelength converter 23, the luminous flux that enters the wavelength converter 23 has a substantially circular luminance distribution, as shown in FIG. 7.

To solve the problems described above, it is desirable that the ratio B/A is close to 1. However, in consideration of the situation in which the illuminator 2 used in the projector 1 illuminates the light modulators 4B, 4G, and 4R fully compatible with the high-definition standard, the size of an effective display area of each of the light modulators 4B, 4G, and 4R is 16:9, and the ratio B/A is therefore desirably at least greater than 9/16 and smaller than or equal to 1.

### Effects of First Embodiment

The illuminator 2 according to the present embodiment includes the first light emitter 311, which has the first light exiting surface 311a and outputs the first light BL1, which belongs to the first wavelength band, via the first light exiting surface 311a, the second light emitter 321, which has the second light exiting surface 321a and outputs the second light BL2, which belongs to the first wavelength band, via the second light exiting surface 321a, the wavelength converter 23, which has the first surface 23a, on which the first light BL1 and the second light BL2 are incident, and the second surface 23b different from the first surface 23a and converts the first light BL1 and the second light BL2 into the fluorescent YL, which belongs to the second wavelength band, the dichroic mirror 21, which reflects one of the set of the first light BL1 and the second light BL2 and fluorescent YL and transmits the other, the first focusing system 35, which is provided between the set of the first light emitter 311 and the second light emitter 321 and the dichroic mirror 21 and has positive power, and the second focusing system 22, which is provided between the dichroic mirror 21 and the wavelength converter 23. The second focusing system 22 has a focal point located between the principal point of the second focusing system 22 and the second surface 23b of the wavelength converter 23. The size of the first light exiting surface 311a and the size of the second light exiting surface 321a are equal to each other and satisfy Expressions (1) and (2) described above.

As described above, in the present embodiment, since the fluorescent YL having a cross-sectional shape close to a circular shape is emitted from the wavelength converter 23, the fluorescent YL can efficiently enter an optical system on the downstream of the wavelength converter 23. An illuminator having high light utilization efficiency can thus be achieved.

The illuminator 2 according to the present embodiment further includes the first light combining mirror 33 and the second light combining mirror 34, which are provided between the set of the first light emitter 311 and the second light emitter 321 and the dichroic mirror 21, on which the first light BL1 outputted from the first light emitter 311 and the second light BL2 outputted from the second light emitter 321 are incident, and which combines the first light BL1 and the second light BL2 with each other.

According to the configuration described above, irrespective of the positions where the first light emitter 311 and the second light emitter 321 are disposed, the luminous flux BL having a cross section so shaped that the ratios B1/A1 and B2/A2 are each close to 1 can be generated by using the first light combining mirror 33 and the second light combining mirror 34 to combine the first light BL1 and the second light BL2 with each other.

The illuminator 2 according to the present embodiment further includes the diffuser 36, which is provided between the set of the first light emitter 311 and the second light emitter 321 and the dichroic mirror 21 and diffuses the first light BL1 outputted from the first light emitter 311 and the second light BL2 outputted from the second light emitter 321.

The configuration described above allows homogenization of the illuminance distribution of the luminous flux BL to be incident on the wavelength converter 23. As a result, an increase in a local temperature of the wavelength converter 23 can be suppressed, whereby a decrease in wavelength conversion efficiency of the wavelength converter 23 can be suppressed.

Further, in the illuminator 2 according to the present embodiment, the diffuser 36 is provided between the first focusing system 35 and the dichroic mirror 21.

According to the configuration described above, since the luminous flux BL focused by the first focusing system 35 enters the diffuser 36, the size of the diffuser 36 can be reduced.

Further, in the illuminator 2 according to the present embodiment, the focal length of the first focusing system 35 is longer than the distance H between the principal point G of the first focusing system 35 and the light incident point N, where the luminous flux BL including the first light BL1 and the second light BL2 is incident on the dichroic mirror 21.

According to the configuration described above, since the focal point F of the first focusing system 35 is located between the dichroic mirror 21 and the first surface 23a of the wavelength converter 23, the size of the dichroic mirror 21 can be reliably reduced. Further, since the second focusing system 22 has a focal point located between the principal point of the second focusing system 22 and the second surface 23b of the wavelength converter 23, the position where the luminous flux width of the luminous flux BL is minimized shifts toward the opposite side of the wavelength converter 23 from the side where the second focusing system 22 is provided. As a result, the image of the luminous flux BL on the first surface 23a of the wavelength converter 23 is defocused, whereby the luminance distribution of the luminous flux BL can be homogenized.

The projector 1 according to the present embodiment includes the illuminator 2 described above, the light modulators 4R, 4G, and 4B, which modulate the light from the illuminator 2 in accordance with image information, and the projection optical apparatus 6, which projects the light modulated by the light modulators 4R, 4G, and 4B.

According to the configuration described above, a highly efficient projector 1 can be achieved.

### Second Embodiment

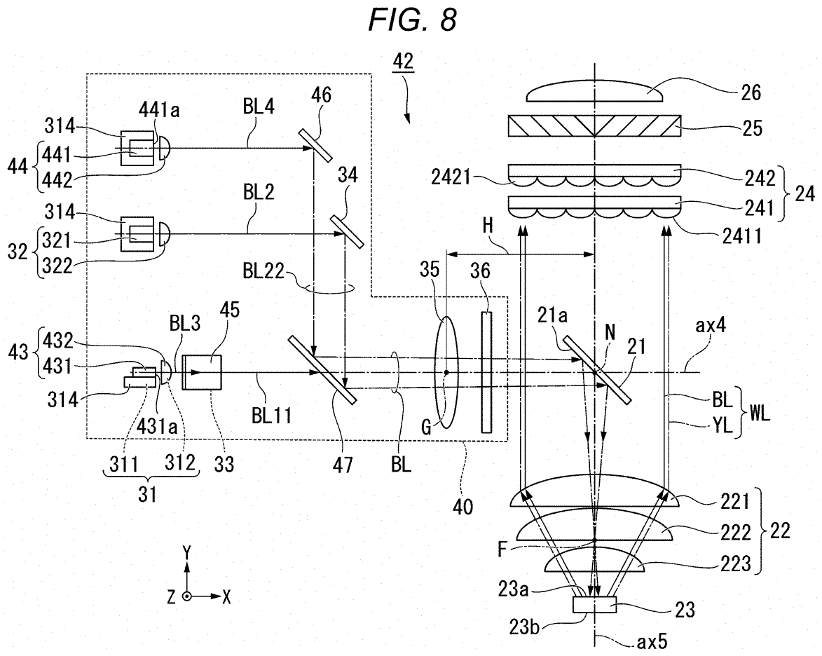

A second embodiment of the present disclosure will be described below with reference to FIGS. 8 to 10.

The configuration of the projector according to the second embodiment is the same as that in the first embodiment, but the configuration of the light source apparatus differs from that in the first embodiment. The overall configurations of the projector and the illuminator will therefore not be described.

FIG. 8 is a schematic configuration diagram of an illuminator 42 according to the second embodiment.

In FIG. 8, components common to those in the figures used in the first embodiment have the same reference characters and will not be described.

The illuminator 42 according to the present embodiment includes a light source apparatus 40, the dichroic mirror 21, the second focusing system 22, the wavelength converter 23, the optical integration system 24, the polarization converter 25, and the superimposing lens 26, as shown in FIG. 8.

The light source apparatus 40 includes the first light source unit 31, the second light source unit 32, a third light source unit 43, a fourth light source unit 44, the first light combining mirror 33, the second light combining mirror 34, a third light combining mirror 45, a fourth light combining mirror 46, a polarized light combining mirror 47, the first focusing system 35, and the diffuser 36. The first light source unit 31 and the second light source unit 32 have the same configurations as those in the first embodiment. The third light source unit 43 includes a third light emitter 431 and a third collimator lens 432. The fourth light source unit 44 includes a fourth light emitter 441 and a fourth collimator lens 442.

The polarized light combining mirror 47 in the present embodiment corresponds to the second optical element in the appended claims.

In the present embodiment, when the configuration in FIG. 8 is viewed in the axis-Y direction, the first light source unit 31, the third light source unit 43, the first light combining mirror 33, and the third light combining mirror 45 are arranged in the same manner in which the first light source unit 31, the second light source unit 32, the first light combining mirror 33, and the second light combining mirror 34 shown in FIG. 3 in the first embodiment are arranged. That is, the first light source unit 31 is so disposed as to coincides with the third light source unit 43 when viewed in the direction toward the rear side (direction −Z) of the plane of view of FIG. 8. The first light combining mirror 33 is so disposed as to coincide with the third light combining mirror 45 when viewed in the direction toward the rear side (direction −Z) of the plane of view of FIG. 8. On the other hand, the second light emitter 321 and the fourth light emitter 441 are disposed with a distance therebetween along the axis-Y direction.

The third light emitter 431 has a third light exiting surface 431a and outputs third light BL3, which belongs to the first wavelength band, via the third light exiting surface 431a in the direction +X. The fourth light emitter 441 has a fourth light exiting surface 441a and outputs fourth light BL4, which belongs to the first wavelength band, via the fourth light emitting surface 441a in the direction +X.

The third light emitter 431 and the fourth light emitter 441 are each formed of a blue semiconductor laser that emits blue light, as the first light emitter 311 and the second light emitter 321 are. The third collimator lens 432 is provided in correspondence with the third light emitter 431 and parallelizes the third light BL3 outputted from the third light emitter 431. The fourth collimator lens 442 is provided in correspondence with the fourth light emitter 441 and parallelizes the fourth light BL4 outputted from the fourth light emitter 441.

The first light BL1 outputted from the first light emitter 311 and the third light BL3 outputted from the third light emitter 431 are combined with each other by the first light combining mirror 33 and the third light combining mirror 45 to produce a first luminous flux BL11.

The second light combining mirror 34 is so disposed that the reflection surface thereof inclines by the angle of 45° with respect to the chief ray of the second light BL2 outputted from the second light emitter 321. The second light BL2 outputted from the second light emitter 321 in the direction +X is therefore reflected off the second light combining mirror 34 and then travels in the direction +Y. The fourth light combining mirror 46 is so disposed that the reflection surface thereof inclines by the angle of 45° with respect to the chief ray of the fourth light BL4 outputted from the fourth light emitter 441. The fourth light BL4 outputted from the fourth light emitter 441 in the direction +X is therefore reflected off the fourth light combining mirror 46 and then travels in the direction +Y. A second luminous flux BL22, which is the combination of the second light BL2 and the fourth light BL4, is thus generated.

The first light emitter 311 outputs the first light BL1 formed of a p-polarized light component with respect to the polarized light combining mirror 47. Similarly, the third light emitter 431 outputs the third light BL3 formed of the p-polarized light component with respect to the polarized light combining mirror 47. The first luminous flux BL11, which is the combination of the first light BL1 and the third light BL3, is therefore formed of the p-polarized light component with respect to the polarized light combining mirror 47. In contrast, the second light emitter 321 outputs the second light BL2 formed of an s-polarized light component with respect to the polarized light combining mirror 47. Similarly, the fourth light emitter 441 outputs the fourth light BL4 formed of the s-polarized light component with respect to the polarized light combining mirror 47. The second luminous flux BL22, which is the combination of the second light BL2 and the fourth light BL4, is therefore formed of the s-polarization light component with respect to the polarized light combining mirror 47.

The p-polarized light component in the present embodiment corresponds to the first light having a first polarization direction in the appended claims. The s-polarized light component in the present embodiment corresponds to the second light having a second polarization direction in the appended claims.

To cause the polarization direction of the light from the set of the first light emitter 311 and the third light emitter 431 with respect to the polarized light combining mirror 47 to differ from the polarization direction of the light from the set of the second light emitter 321 and the fourth light emitter 441 with respect to the polarized light combining mirror 47, for example, one of the two sets of light emitters may be so rotated with respect to the other by 90° when viewed from the light exiting direction so that the lengthwise directions of the light exiting surfaces in the two sets are perpendicular to each other. When the four light emitters are all disposed in the same orientation, a half wave plate may be disposed on the light exiting side of one of the sets to rotate the polarization direction of only the light outputted from the set of light emitters provided with the half wave plate.

The polarized light combining mirror 47 is so disposed as to incline by the angle of 45° with respect to each of the chief ray of the first luminous flux BL11 and the chief ray of the second luminous flux BL22. The polarized light combining mirror 47 is so characterized as to transmit the p-polarized light component with respect to the polarized light combining mirror 47 and reflect the s-polarized light component with respect thereto. Therefore, since the first luminous flux BL11 passes through the polarized light combining mirror 47 and the second luminous flux BL22 is reflected off the polarized light combining mirror 47, both the first luminous flux BL11 and the second luminous flux BL22 travel in the direction +X. The first light BL1, the second light BL2, the third light BL3, and the fourth light BL4 are thus all combined with one another into a single combined luminous flux, which enters the first focusing system 35.

The other configurations of the illuminator 42 are the same as those of the illuminator 2 according to the first embodiment.

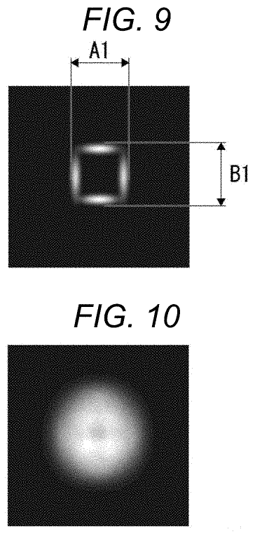

FIG. 9 shows the luminance distribution of the luminous flux BL after the first light BL1, the second light BL2, the third light BL3, and the fourth light BL4 are combined with one another.

In the present embodiment, the first light BL1 and the third light BL3 are so disposed as to be separate from each other along the widthwise direction of the elliptical cross-sectional shapes of the first light BL1 and the third light BL3. On the other hand, the second light BL2 and the fourth light BL4 are so disposed as to be separate from each other in the widthwise direction of the elliptical cross-sectional shapes of the second light BL2 and the fourth light BL4, the widthwise direction being perpendicular to the widthwise direction of the elliptical cross-sectional shapes of the first light BL1 and the third light BL3. The first light BL1, the second light BL2, the third light BL3, and the fourth light BL4 can therefore be arranged along the edges of a square to form a luminous flux having a substantially square shape, as shown in FIG. 9, by adjusting the positions of the light combining mirrors 33, 45, 34, and 46 to adjust the distance between the first light BL1 and the third light BL3 and the distance between the second light BL2 and the fourth light BL4.

In the present embodiment, let A1 be the lengthwise dimension of the cross-sectional shape of the luminous flux BL formed of the first light BL1, the second light BL2, the third light BL3, and the fourth light BL4 and B1 be the widthwise dimension of the cross-sectional shape of the luminous flux BL, and the ratio B1/A1 of the dimension B1 to the dimension A1 is approximately 1. The relationship between the ratio B1/A1 and the ratio D1/C1 therefore satisfies Expression (1) shown in the first embodiment. Further, as in the first embodiment, the relationship between the ratio B2/A2 and the ratio D2/C2 satisfies Expression (2) shown in the first embodiment. As a result, the luminance distribution of the luminous flux BL incident on the wavelength converter 23 has a substantially circular shape, as shown in FIG. 10. When the cross-sectional shape of the luminous flux BL is a perfect square, there is no distinction between the lengthwise direction and the widthwise direction of the square. Therefore, the dimension of any one edge of the square may be considered as the lengthwise dimension, and the dimension of an edge perpendicular to the one edge may be considered as the widthwise dimension.

### Effects of Second Embodiment

Also in the present embodiment, since the fluorescent YL having a cross-sectional shape close to a circular shape is emitted from the wavelength converter 23, the same effects as those provided by the first embodiment can be provided, for example, an illuminator 42 having high light utilization efficiency can be achieved, and a highly efficient projector 1 can be achieved.

Further, the illuminator 42 according to the present embodiment includes the polarized light combining mirror 47, and the polarized light combining mirror 47 reflects the second luminous flux BL22, which is formed of the s-polarized light component with respect to the polarized light combining mirror 47, and transmits the first luminous flux BL11, which is formed of the p-polarized light component with respect to the polarized light combining mirror 47.

The configuration described above readily allows formation of a luminous flux BL in which a plurality of light beams each having an elliptical cross section are so arranged that the lengthwise directions thereof are perpendicular to each other, for example, the luminous flux BL in which a plurality of light beams are arranged in a square shape, as in the present embodiment.

### Third Embodiment

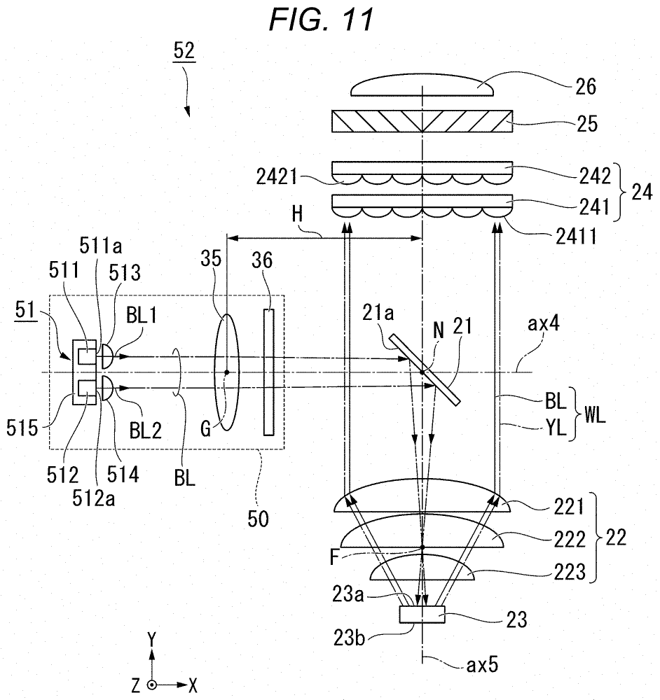

A third embodiment of the present disclosure will be described below with reference to FIGS. 11 to 13.

The configuration of the projector according to the third embodiment is the same as that in the first embodiment, but the configuration of the light source apparatus differs from that in the first embodiment. The overall configurations of the projector and the illuminator will therefore not be described.

FIG. 11 is a schematic configuration diagram of an illuminator 52 according to the third embodiment.

In FIG. 11, components common to those in the figures used in the first embodiment have the same reference characters and will not be described.

The illuminator 52 according to the present embodiment includes a light source device 50, the dichroic mirror 21, the second focusing system 22, the wavelength converter 23, the optical integration system 24, the polarization converter 25, and the superimposing lens 26, as shown in FIG. 11. The light source apparatus 50 includes a light source unit 51, the first focusing system 35, and the diffuser 36. That is, the illuminator 52 according to the present embodiment includes no light combiner that combines the first light BL1 and the second light BL2 with each other.

The light source unit 51 includes a first light emitter 511, a second light emitter 512, a first collimator lens 513, a second collimator lens 514, and a base 515. The first light emitter 511 and the second light emitter 512 are held by the base 515. The first light emitter 511 and the second light emitter 512 are so disposed as to be separate from each other in the axis-Y direction along the lengthwise direction of the light exiting surfaces of the light emitters 511 and 512. The first collimator lens 513 is provided in correspondence with the first light emitter 511. The second collimator lens 514 is provided in correspondence with the second light emitter 512.

The other configurations of the illuminator 52 are the same as those of the illuminator 2 according to the first embodiment.

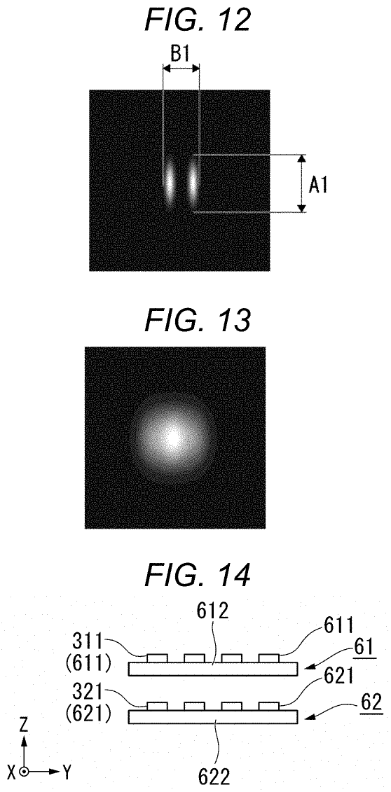

FIG. 12 shows the luminance distribution of the luminous flux BL including the first light BL1 and the second light BL2.

In the present embodiment, the luminous flux BL outputted from the light source unit 51 can have a cross-sectional shape in which two light beams are so disposed as to be separate from each other in the widthwise direction of the cross-sectional shapes of the luminous fluxes, as shown in FIG. 12, by arranging the first light emitter 511 and the second light emitter 512 along the lengthwise direction of light exiting surfaces 511a and 512a of the light emitters and adjusting the distance between the two light emitters 511 and 512 as appropriate.

In FIG. 12, let A1 be the lengthwise dimension of the cross-sectional shape of the luminous flux BL including the first light BL1 and the second light BL2 and B1 be the widthwise dimension of the cross-sectional shape of the luminous flux BL, and the ratio B1/A1 of the dimension B1 to the dimension A1 is close to 1. The relationship between the ratio B1/A1 and the ratio D1/C1 therefore satisfies Expression (1) shown in the first embodiment. Further, the relationship between the ratio B2/A2 and the ratio D2/C2 satisfies Expression (2) shown in the first embodiment. As a result, the luminance distribution of the luminous flux incident on the wavelength converter 23 has a substantially circular shape, as shown in FIG. 13.

### Effects of Third Embodiment

Also in the present embodiment, since the fluorescent YL having a cross-sectional shape close to a circular shape is emitted from the wavelength converter 23, the same effects as those provided by the first embodiment can be provided, for example, an illuminator 52 having high light utilization efficiency can be achieved, and a highly efficient projector 1 can be achieved.

Further, since the illuminator 52 according to the present embodiment includes no light combiner that combines the first light BL1 and the second light BL2 with each other, the configuration of the illuminator 52 can be simplified.

### 4. Fourth Embodiment

A fourth embodiment of the present disclosure will be described below with reference to FIGS. 14 to 16.

The configuration of the projector according to the fourth embodiment is the same as that in the first embodiment, and the configuration of the illuminator is the same as that in the third embodiment, but the configuration of the light source apparatus differs from that in the third embodiment. The overall configurations of the projector and the illuminator will therefore not be described.

FIG. 14 is a schematic configuration diagram showing a light source unit out of the light source apparatus in the fourth embodiment.

In FIG. 14, components common to those in the figures used in the third embodiment have the same reference characters and will not be described.

The light source apparatus in the present embodiment includes a first light source unit 61, a second light source unit 62, the first focusing system 35 (see FIG. 11), and the diffuser 36 (see FIG. 11), as shown in FIG. 14. That is, the light source apparatus in the present embodiment includes no light combiner, as the light source apparatus in the third embodiment does.

The first light source unit 61 includes four light emitters 611 including the first light emitter 311, four collimator lenses including a first collimator lens that are not shown, and a base 612. The four light emitters 611 are so disposed as to be separate from each other in the axis-Y direction along the lengthwise direction of the light exiting surfaces of the light emitters 611 and held by the base 612. The four collimator lenses are provided in correspondence with the respective four light emitters 611.

The second light source unit 62 has the same configuration as the first light source unit 61. That is, the second light source unit 62 has four light emitters 621 including the second light emitter 321, four collimator lenses including a second collimator lens that are not shown, and a base 622. The four light emitters 621 are so disposed as to be separate from each other in the axis-Y direction along the lengthwise direction of the light exiting surfaces of the light emitters 621 and held by the base 622. The four collimator lenses are provided in correspondence with the respective four light emitters 621.

The other configurations of the light source apparatus are the same as those of the light source apparatus in the third embodiment.

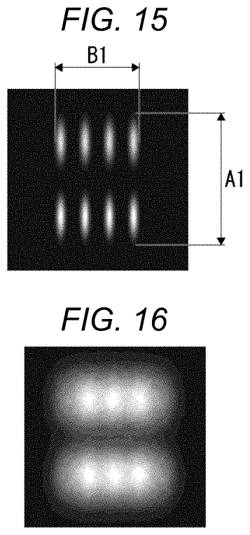

FIG. 15 shows the luminance distribution of the luminous flux BL including the eight light beams outputted from the eight light emitters 611 and 621.

In the present embodiment, the luminous flux BL formed of the eight light beams outputted from the first light source unit 61 and the second light source unit 62 can be so shaped that four light beams are separate from each other in the widthwise direction of the elliptical cross-sectional shapes of the light beams and the sets each formed of four light beams are separate from each other in the lengthwise direction of the elliptical cross-sectional shapes, as shown in FIG. 15, by arranging the four light emitters 611 and the four light emitters 621 in the light source units 61 and 62 along the lengthwise direction of the light exiting surfaces of the light emitters, adjusting the distance between the light emitters, and adjusting the distance between the first light source unit 61 and the second light source unit 62.

In FIG. 15, let A1 be the lengthwise dimension of the cross-sectional shape of the luminous flux BL and B1 be the widthwise dimension of the cross-sectional shape of the luminous flux BL, and the ratio B1/A1 of the dimension B1 to the dimension A1 is close to 1. The relationship between the ratio B1/A1 and the ratio D1/C1 therefore satisfies Expression (1) shown in the first embodiment. Further, the relationship between the ratio B2/A2 and the ratio D2/C2 satisfies Expression (2) shown in the first embodiment. As a result, the luminance distribution of the luminous flux BL incident on the wavelength converter 23 has a shape close to a square shape, as shown in FIG. 16.

### Effects of Fourth Embodiment

Also in the present embodiment, since the fluorescent YL having a cross-sectional shape close to a circular shape is emitted from the wavelength converter 23, the same effects as those provided by the first embodiment can be provided, for example, an illuminator having high light utilization efficiency can be achieved, and a highly efficient projector can be achieved.

Further, since the illuminator according to the present embodiment includes no light combiner, the same effects as those provided by the third embodiment can be provided, for example, the configuration of the illuminator can be simplified.

The technical scope of the present disclosure is not limited to the embodiments described above, and a variety of changes can be made thereto to the extent that the changes do not depart from the substance of the present disclosure.

For example, the illuminator according to each of the embodiments described above includes the dichroic mirror that reflects the blue light component and transmits the yellow light component, and may instead include a dichroic mirror that transmits the blue light component and reflects the yellow light component. In the configuration described above, since the luminous fluxes outputted from the first and second light emitters pass through the dichroic mirror, the wavelength converter may be disposed in a position where the wavelength converter faces the light emitters with the dichroic mirror sandwiched therebetween.

Further, the above embodiments have been described with reference to an immobile wavelength converter configured not to be rotatable, and the present disclosure is also applicable to an illuminator including a wavelength converter configured to be rotatable by a motor.

In addition to the above, the specific descriptions of the shape, the number, the arrangement, the material, and other factors of the components of the illuminators and the projectors are not limited to those in the embodiments described above and can be changed as appropriate. The above embodiments have been described with reference to the case where the illuminators according to the present disclosure are each incorporated in a projector using liquid crystal light valves, but not necessarily. The illuminators according to the present disclosure may each be incorporated in a projector using a digital micromirror device as each of the light modulators. The projectors may not each include a plurality of light modulators and may instead include only one light modulator.

The above embodiments have been described with reference to the case where the illuminators according to the present disclosure are each incorporated in a projector, but not necessarily. The illuminators according to the present disclosure may each be used as a lighting apparatus, a headlight of an automobile, and other components.

An illuminator according to an aspect of the present disclosure may have the configuration below.

An illuminator according to an aspect of the present disclosure includes a first light emitter that has a first light exiting surface and outputs first light that belongs to a first wavelength band via the first light exiting surface, a second light emitter that has a second light exiting surface and outputs second light that belongs to the first wavelength band via the second light exiting surface, a wavelength converter that has a first surface on which the first light and the second light are incident and a second surface different from the first surface and converts the first light and the second light into third light that belongs to a second wavelength band different from the first wavelength band, a first optical element that reflects one of the set of the first light and the second light and the third light and transmits the other, a first focusing system that is provided between the set of the first light emitter and the second light emitter and the first optical element and has positive power, and a second focusing system provided between the first optical element and the wavelength converter, in which the second focusing system has a focal point located between the principal point of the second focusing system and the second surface of the wavelength converter, the first light exiting surface and the second light exiting surface have the same size, and

D1/C1<B1/A1≤1 (1)

where C1 represents the lengthwise size of the first light exiting surface and the second light exiting surface, D1 represents the widthwise size of the first light exiting surface and the second light exiting surface, A1 represents the lengthwise size of a cross section of a luminous flux that is the combination of the first light and the second light that is the cross section perpendicular to the chief ray of the luminous flux between the set of the first light emitter and the second light emitter and the first optical element, and B1 represents the widthwise size of the cross section therebetween.

An illuminator according to another aspect of the present disclosure includes a first light emitter that outputs first light that belongs to a first wavelength band, a second light emitter that outputs second light that belongs to the first wavelength band, a wavelength converter that has a first surface on which the first light and the second light are incident and a second surface different from the first surface and converts the first light and the second light into third light that belongs to a second wavelength band different from the first wavelength band, a first optical element that reflects one of the set of the first light and the second light and the third light and transmits the other, a first focusing system that is provided between the set of the first light emitter and the second light emitter and the first optical element and has positive power, and a second focusing system provided between the first optical element and the wavelength converter, in which the second focusing system has a focal point located between the principal point of the second focusing system and the second surface of the wavelength converter, a first cross section perpendicular to the chief ray of the first light and a second cross section perpendicular to the chief ray of the second light have the same size between the set of the first light emitter and the second light emitter and the first optical element and

D2/C2<B2/A2≤1 (2)

where C2 represents the lengthwise size of the first cross section and the second cross section, D2 represents the widthwise size of the first cross section and the second cross section, A2 represents the lengthwise size of a third cross section of a luminous flux that is the combination of the first light and the second light that is the cross section perpendicular to the chief ray of the luminous flux between the set of the first light emitter and the second light emitter and the first optical element, and B2 represents the widthwise size of the third cross section therebetween.

The illuminator according to the aspect of the present disclosure may further include a second optical element that is provided between the set of the first light emitter and the second light emitter and the first optical element, that at least one of the first light outputted from the first light emitter and the second light outputted from the second light emitter enters, and that combines the first light and the second light with each other, and the cross section may extend along a plane perpendicular to the chief ray of the luminous flux having exited out of the second optical element between the second optical element and the first optical element.

The illuminator according to the aspect of the present disclosure may further include a second optical element that is provided between the set of the first light emitter and the second light emitter and the first optical element, that at least one of the first light outputted from the first light emitter and the second light outputted from the second light emitter enters, and that combines the first light and the second light with each other, and the third cross section may extend along a plane perpendicular to the chief ray of the luminous flux having exited out of the second optical element between the second optical element and the first optical element.

In the illuminator according to the aspect of the present disclosure, the first light emitter may output the first light having a first polarization direction, the second light emitter may output the second light having a second polarization direction different from the first polarization direction, and the second optical element may reflect one of the first light having the first polarization direction and the second light having the second polarization direction and transmit the other.

The illuminator according to the aspect of the present disclosure may further include a diffuser that is provided between the set of the first light emitter and the second light emitter and the first optical element and diffuses the first light outputted from the first light emitter and the second light outputted from the second light emitter.

In the illuminator according to the aspect of the present disclosure, the diffuser may be provided between the first focusing system and the first optical element.

In the illuminator according to the aspect of the present disclosure, the focal length of the first focusing system may be longer than the distance between the principal point of the first focusing system and a light incident point where a luminous flux including the first light and the second light is incident on the first optical element.

A projector according to another aspect of the present disclosure may have the configuration below.

A projector according to the other aspect of the present disclosure includes the illuminator according to the aspect of the present disclosure, a light modulator that modulates light from the illuminator in accordance with image information, and a projection optical apparatus that projects the light modulated by the light modulator.

What is claimed is:

1. An illuminator comprising:
a first light emitter that has a first light exiting surface and outputs first light that belongs to a first wavelength band via the first light exiting surface;
a second light emitter that has a second light exiting surface and outputs second light that belongs to the first wavelength band via the second light exiting surface;
a wavelength converter that has a first surface on which the first light and the second light are incident and a second surface different from the first surface and converts the first light and the second light into third light that belongs to a second wavelength band different from the first wavelength band;
a first optical element that reflects one of a set of the first light and the second light and the third light and transmits the other of the set of the first light and the second light and the third light;
a first focusing system that is provided between a set of the first light emitter and the second light emitter and the first optical element and has positive power; and
a second focusing system provided between the first optical element and the wavelength converter, wherein
the second focusing system has a focal point located between a principal point of the second focusing system and the second surface of the wavelength converter,
the first light exiting surface and the second light exiting surface have the same size, and
D1/C1<B1/A1≤1 (1)
where C1 represents a lengthwise size of the first light exiting surface and the second light exiting surface, D1 represents a widthwise size of the first light exiting surface and the second light exiting surface, A1 represents a lengthwise size of a cross section of a luminous flux that is a combination of the first light and the second light, the a cross section being perpendicular to a chief ray of the luminous flux, between the set of the first light emitter and the second light emitter and the first optical element, and B1 represents a widthwise size of the cross section therebetween.

2. An illuminator comprising:
a first light emitter that outputs first light that belongs to a first wavelength band;
a second light emitter that outputs second light that belongs to the first wavelength band;
a wavelength converter that has a first surface on which the first light and the second light are incident and a second surface different from the first surface and converts the first light and the second light into third light that belongs to a second wavelength band different from the first wavelength band;
a first optical element that reflects one of a set of the first light and the second light and the third light and transmits the other of the set of the first light and the second light and the third light;
a first focusing system that is provided between a set of the first light emitter and the second light emitter and the first optical element and has positive power; and
a second focusing system provided between the first optical element and the wavelength converter, wherein
the second focusing system has a focal point located between a principal point of the second focusing system and the second surface of the wavelength converter,
a first cross section perpendicular to a chief ray of the first light and a second cross section perpendicular to a chief ray of the second light have the same size between the set of the first light emitter and the second light emitter and the first optical element, and
D2/C2<B2/A2≤1 (2)
where between the set of the first light emitter and the second light emitter and the first optical element, C2 represents a lengthwise size of the first cross section and the second cross section, D2 represents a widthwise size of the first cross section and the second cross section, A2 represents a lengthwise size of a third cross section of a luminous flux that is a combination of the first light and the second light, the cross section being perpendicular to a chief ray of the luminous flux, and B2 represents a widthwise size of the third cross section therebetween.

3. The illuminator according to claim 1,
further comprising a second optical element that is provided between the set of the first light emitter and the second light emitter and the first optical element, that at least one of the first light outputted from the first light emitter and the second light outputted from the second light emitter enters, and that combines the first light and the second light with each other, wherein
the cross section extends along a plane perpendicular to a chief ray of the luminous flux that exits out of the second optical element between the second optical element and the first optical element.

4. The illuminator according to claim 2,
further comprising a second optical element that is provided between the set of the first light emitter and the second light emitter and the first optical element, that at least one of the first light outputted from the first light emitter and the second light outputted from the second light emitter enters, and that combines the first light and the second light with each other, wherein
the third cross section extends along a plane perpendicular to a chief ray of the luminous flux that exits out of the second optical element between the second optical element and the first optical element.

5. The illuminator according to claim 3, wherein
the first light emitter outputs the first light having a first polarization direction,
the second light emitter outputs the second light having a second polarization direction different from the first polarization direction, and
the second optical element reflects one of the first light having the first polarization direction and the second light having the second polarization direction and transmit the other of the first light and the second light.

6. The illuminator according to claim 1, further comprising a diffuser that is provided between the set of the first light emitter and the second light emitter and the first optical element and diffuses the first light outputted from the first light emitter and the second light outputted from the second light emitter.

7. The illuminator according to claim 6, wherein the diffuser is provided between the first focusing system and the first optical element.

8. The illuminator according to claim 1, wherein a focal length of the first focusing system is longer than a distance between a principal point of the first focusing system and a light incident point where a luminous flux including the first light and the second light is incident on the first optical element.

9. A projector comprising:
the illuminator according to claim 1;
a light modulator that modulates light from the illuminator in accordance with image information; and
a projection optical apparatus that projects the light modulated by the light modulator.
